(19) United States
(12) Patent Application Publication
(10) Pub. No.: US 2018/0082559 A1
(43) Pub. Date: Mar. 22, 2018

(54) ZONE ENTRY WARNING SYSTEM AND DEVICE

(71) Applicant: R&D Ventures Pty Ltd, North Ryde (AU)

(72) Inventors: Ryan David NORRIS, North Ryde (AU); David MOUSSA, North Ryde (AU)

(21) Appl. No.: 15/705,846

(22) Filed: Sep. 15, 2017

(30) Foreign Application Priority Data
Sep. 21, 2016 (AU) 2016903797

(51) Int. Cl. G08B 21/02; H04B 1/08; G02C 9/04

(52) U.S. Cl. CPC G08B 21/02; G02C 9/04; H04B 1/086

(57) ABSTRACT

The present disclosure relates to the field of safety and warning devices, such as a system for zone entry warning. The present disclosure utilizes attaching a stretchable band to the worker enabling the warning of the worker that they are proximate a demarcated zone.

### CROSS-REFERENCE TO RELATED APPLICATIONS

The present application claims priority to Australian Provisional Patent Application No. 2016903797, entitled “Zone Entry Warning System and Device,” filed on Sep. 21, 2016, the entire contents of which are hereby incorporated by reference for all purposes.

### FIELD

The present disclosure relates to the field of safety and warning devices.

In one form, the present disclosure relates to a wearable, reusable device for receiving zone entry warning signals.

In another form the present disclosure relates to a system for zone entry warning.

In one particular aspect the present disclosure is suitable for receiving warning signals associated with hazards.

It will be convenient to hereinafter describe the present disclosure in relation to the mining and construction industries and associated sites. However, it should be appreciated that the present disclosure extends to a wide range of industries which have site hazards including the manufacturing industry, energy industry, transport and ship building industries. Furthermore, the site hazards are principally discussed with reference to collisions with moving vehicles and equipment, but it should be appreciated that the present disclosure is not so limited and includes a wide range of hazards including fall hazards, electrical hazards and radiation exposure hazards.

### BACKGROUND ART

It is to be appreciated that any discussion of documents, devices, acts or knowledge in this specification is included to explain the context of the present disclosure. Further, the discussion throughout this specification comes about due to the realization of the inventor and/or the identification of certain related art problems by the inventor. Moreover, any discussion of material such as documents, devices, acts or knowledge in this specification is included to explain the context of the present disclosure in terms of the inventor's knowledge and experience and, accordingly, any such discussion should not be taken as an admission that any of the material forms part of the prior art base or the common general knowledge in the relevant art in Australia, or elsewhere, on or before the priority date of the disclosure and claims herein.

Workers at mining and construction sites often face risks of injury due to the dynamic interaction of people, machines, equipment and materials. Site layouts, particularly in constrained spaces, can produce dangerous situations in which workers and equipment have to operate in close proximity. These dangerous situations include fall risks, risks associated with unstable structures, and the risk of being hit by moving vehicles or equipment. At mining and demolition site zones workers need to be excluded from areas loaded with explosives.

One significant source of injuries are collisions that arise due to the blind spots experienced by equipment operators, particularly during turning or reversing movements. For example, factories often have numerous forklift trucks darting about on a factory floor where there is also a high density of personnel. The operator's vision is often limited when they negotiate narrow thoroughfares and turn corners.

Injury risk is not only relevant to equipment such as moving vehicles, but also stationary equipment such as cranes. Workers on construction sites have suspended loads passing over them all day and the crane operator and a spotter have to work together to ensure that no one works directly under the load or is nearby when the load is lowered and set down.

While automated warning technologies exist, they are expensive and infrastructure heavy. The technology may then limit the operation of the vehicle, such as by shutting it down. These types of prior art systems are not easily implemented, require hardwired changes to the vehicle and substantial user training. Only the most motivated employer with considerable resources can utilize this type of technology.

On most sites occupational health and safety regulations require implementation of appropriate training, education and safety devices such as hard hats, safety glasses, ear muffs, reflective safety vests and other personal protective equipment. However, these do not provide alerts for site workers in real time when they enter a hazardous area.

Furthermore, physical fatigue and the repetitive nature of construction tasks can cause workers to experience a decrease in awareness of surroundings and loss of mental focus. This can lead to them inadvertently moving into hazardous areas without recognizing the hazard.

As a result, personalized hazard warning systems have been developed for site workers. These include numerous pro-active technologies such as comparative active (battery-powered) radio frequency devices. Battery-free systems have also been developed, such as the Self-Monitoring Alert and Reporting Technology for Hazard Avoidance and Training (SmartHat), a sensing and communication system that provides alerts in real-time when hazardous proximity conditions arise between heavy construction equipment and ground workers.

A Hazardous Area Signalling and Ranging Device (HASARD) operates on magnetic waves emitted from a transmitter which are used to activate an alarm when a worker enters a magnetic field. Sensors are placed on workers and on mine walls to warn of collisions with underground mining machines. Radio frequency (RF) technology has been used in relation to forklifts when they operate in small spaces in warehouses, and have limited operator visibility.

However, many automated technologies such as radio detection and ranging, sonar, global positioning systems, radio transceiver tags have limitations when used on construction or mining sites, such as availability of signal, signal read range, weight, size, power source, reliability and robustness.

### SUMMARY

Example embodiments of the present application may provide improved wearable personal protective equipment to communicate zone entry warnings.

Further, embodiments may provide a pro-active option for enhancing on-site safety.

Embodiments of the present application may also alleviate at least one disadvantage associated with the related art.

Embodiments described herein may overcome or alleviate at least one of the above noted drawbacks of related art systems or at least provide a useful alternative to related art systems.

In a first example embodiment described herein there is provided a wearable device associated with a zone entry warning device, wherein the device comprises a receiver associated with a stretchable band. The receiver may be embedded in the stretchable band.

In another example embodiment described herein there is provided a system for zone entry warning, the system comprising:
a transmitter adapted to provide as an output, a signal from a predetermined zone,
a zone entry warning device,
a wearable receiver associated with a stretchable band, preferably embedded, the receiver being adapted to be responsive to said signal when proximate the zone and to initiate said zone entry warning device.

In a further example embodiment described herein there is provided a method for zone entry warning, the method comprising:
locating a transmitter proximate a predetermined zone, the transmitter being adapted to provide a signal as an output,
removably attaching a zone entry warning device to a subject,
removably attaching a stretchable band to the subject, the stretchable band comprising a receiver, the receiver being adapted to be responsive to the signal when proximate the zone and to initiate the zone entry warning device.

Typically the transmitter is located in a zone which has been predetermined to be associated with a hazard or associated with a situation that may cause injury. For example the zone may be hazardous due to the presence of moving vehicles, operating equipment, loads suspended from cranes, fall risks (such as exposed ledges, unstable buildings or unstable ground), confined spaces or blast exclusion zones. The transmitter may be of any type well known in the technology such as a radio transmitter. Typically the receiver is passive, that is, the receiver does not transmit signals and only detects the signal emitted from the transmitter.

Typically the stretchable band comprises one or more natural or synthetic polymers which can be resiliently deformed and are robust, durable and water resistant. In one embodiment the stretchable band may comprise silicone.

Typically the stretchable band is in the form of a closed loop which can be quickly removably attached to the frame of safety spectacles, optionally the arm.

Typically the zone entry warning device emits a visual signal or aural signal and is located within visual or hearing range of the wearer so that it comes to the wearer's attention immediately and reliably. For example, the zone entry warning device may be in the form of an LED light. The zone entry warning device may be incorporated in the stretchable band or the wearer's hard hat or other apparel.

In one embodiment of the disclosure the wearable receiver and zone entry warning device may both be embedded in the stretchable band.

Optionally, in use the stretchable band is located on the frame of the safety glasses proximate the user's eye and the hazard warning device generates visual warnings. Locating a visual hazard warning such as an LED within the wearer's field of vision is advantageous because any illumination of the LED immediately warns the wearer that they are about to enter a predetermined zone. Many polymers such as silicone are transparent or semi-transparent so that the illumination of the LED readily passes through the polymer.

The device of the present disclosure may be removably attached to the wearer's glasses and can be fitted to any make, design or size of glasses that is preferred by the user. The device can also be and can be transferred from a first set of glasses to a second set of glasses if the first set is damaged or dirty.

One of the disadvantages associated with some warning systems of the prior art is that they included elements that had to be incorporated into the safety spectacle frames during manufacture. This necessitates certification under International Standards and compliance testing that increases the cost and complexity of manufacture.

By contrast, the device of the present disclosure is economical to manufacture and treated as a consumable that can be discarded when the battery is expended and readily replaced.

In another aspect of embodiments described herein there is provided a method of attaching a receiver, including the step of removably attaching the device to spectacle frames.

Other aspects and preferred forms are disclosed in the specification and/or defined in the appended claims, forming a part of the description of the present disclosure.

In essence, embodiments of the present disclosure stem from the realization that a key element of device for warning a worker that they are proximate a demarcated zone is optimally attached to the worker using a stretchable band.

Advantages provided by the present disclosure comprise the following:
decreases risk of entry to zones which pose a hazard for injury,
provide alerts in real time for workers,
operates with minimal nuisance or false alerts,
provide real time alerts at different pre-calibrated proximity ranges,
can be used on a range of styles and types of safety equipment,
can be moved from one item of safety equipment to another,
inexpensive to manufacture and replace, with concomitant low price point per employee,
no training, infrastructure or maintenance required,
robust, water and dirt resistant,
light weight and ergonomic.

Further scope of applicability of embodiments of the present disclosure will become apparent from the detailed description given hereinafter. However, it should be understood that the detailed description and specific examples, while indicating optional embodiments of the present disclosure, are given by way of illustration only, since various changes and modifications within the spirit and scope of the disclosure herein will become apparent to those skilled in the art from this detailed description.

### BRIEF DESCRIPTION OF THE DRAWINGS

This application contains at least one drawing executed in color. Copies of this patent or patent application publication with color drawing(s) will be provided by the Office upon request and payment of the necessary fee.

Further disclosure, objects, advantages and aspects of preferred and other embodiments of the present application may be better understood by those skilled in the relevant art by reference to the following description of embodiments taken in conjunction with the accompanying drawings, which are given by way of illustration only, and thus are not limitative of the disclosure herein, and in which:

FIG. 1 illustrates a device according to the present disclosure in front view.

FIG. 2 illustrates the device if FIG. 1 in perspective view.

FIG. 3 illustrates the device of FIG. 1 in cross-sectional view.

FIG. 4 illustrates the device of FIG. 1 in exploded view.

FIG. 5 illustrates a perspective view of a pair of safety spectacles to which the device of FIG. 1 has been attached.

FIG. 6 illustrates a side view of the safety spectacles and device of FIG. 5.

FIG. 7 illustrates a front view of the safety spectacles and device of FIG. 5.

FIG. 8 illustrates a top view of the safety spectacles and device of FIG. 5.

### DETAILED DESCRIPTION

The system for zone entry and personal wearable device of the present disclosure will alert a wearer to a hazard in their proximity as demarcated by a zone established by a transmitter.

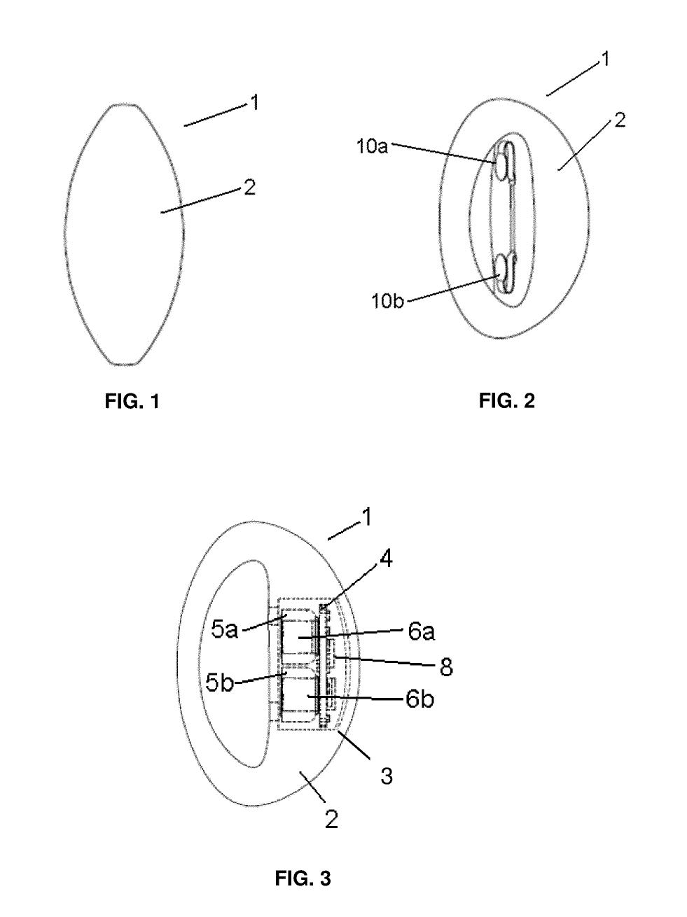

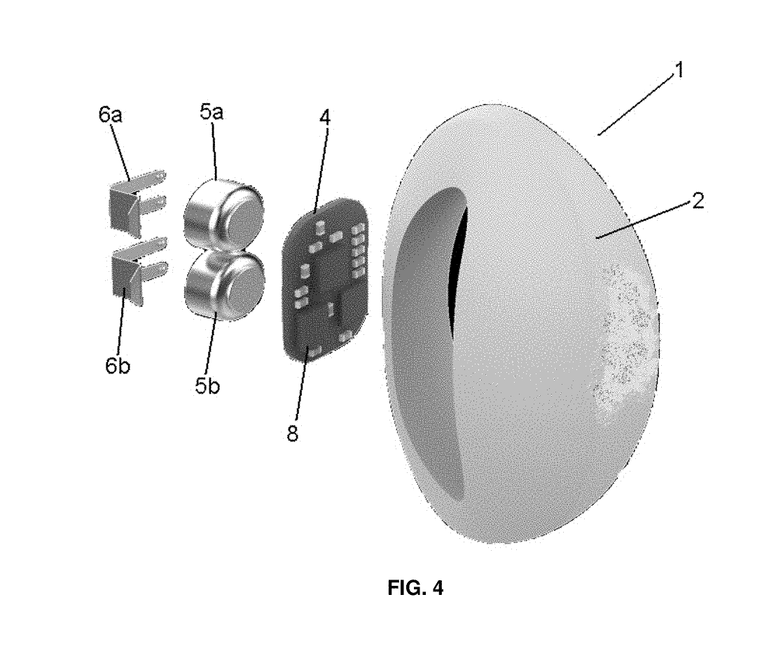

As shown in FIGS. 1 to 4, the device (1) consists of a silicone body (2) configured as a closed loop in which is embedded a receiver (3). The receiver in this embodiment comprises a PCB (4), two A10 coin cell batteries (5a, 5b) held against the PCB (4) by their respective retainers (6a, 6b). Zone entry warning devices in the form of LEDs (8) are located in the center of both sides of the PCB (4). Locating the LEDs (8) on both sides allows the device to be attached onto either side of the safety spectacle frame. Battery pull tabs (10a, 10b) can be pulled to activate the batteries (5). The batteries may be of any convenient type such as those that last 2 to 3 months.

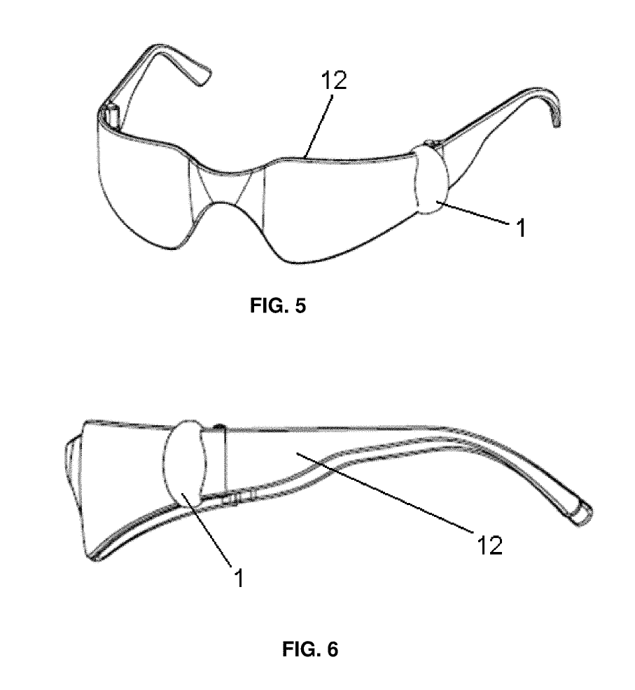

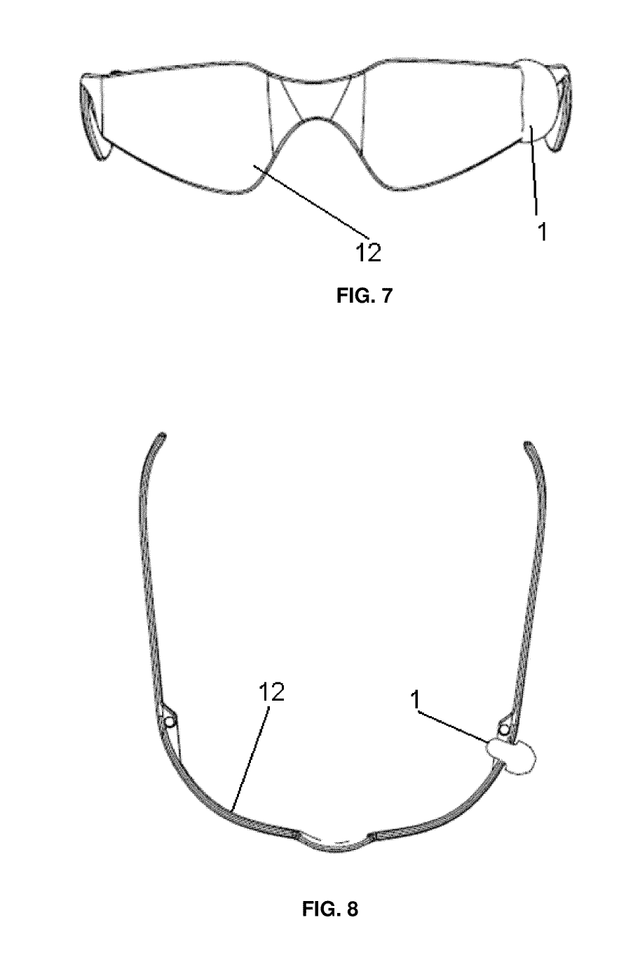

The device (1) may be attached to the wearer's safety spectacles (12) as shown in FIGS. 5 to 8.

Typically the maximum communication distance between the transmitter and receiver is about 50 meters. Typically the receiver activates the zone entry warning device when the transmitter is at a distance of 5 to 50 meters, optionally a distance of 5 to 20 meters, further optionally a distance of 5 to 10 meters.

One embodiment of the system of the present disclosure utilizes an unlicensed industrial, scientific and medical (ISM) radio band, with the frequency of operation depending on the country in which it is deployed (e.g. 915 to 928 MHz in Australia, 868 to 870 MHz in Europe or 902 to 928 MHz in USA or Canada). However, it will readily be apparent to the person skilled in the art that the system is not limited to this band and can be operated at other commonly used frequency bands such as the unlicensed 433 MHz band and the proprietary 2.4 to 5 GHz band.

The transmitter, or multiple transmitters, can be temporarily or permanently positioned to demarcate various hazard zones throughout a work site. For example, the transmitter may have a magnetic base to enable it to be removably attached to various vehicles or metal structures. Alternatively the transmitter may include a spike so that it can be located in earth adjacent to the perimeter of a deep excavation or earthen unsafe ledge. Alternatively the transmitter may be incorporated into an existing warning device such as a safety cone.

For example the transmitter may be attached to a load on a crane, so that workers are warned that the load is nearby and can avoid being directly under the load when it is lowered. The system of the present disclosure is particularly useful for workers operating loud machinery because it provides visual notification of the proximity of the crane load.

When the transmitter is mounted on vehicles such as forklifts, the system of the present disclosure can alert workers to vehicles entering their work zone and is particularly useful for vehicles entering their work zone from a blind spot.

The transmitter may be permanently activated, activated by timer, or activated by some extrinsic force such as vibrations upon start-up of a vehicle engine.

The device of the present disclosure allows the user to recognize a hazard zone and avoid the area. For example, the transmitter can be installed in static locations from which they must be excluded because they contain hazards such as explosives, high voltage electricity or deep holes or for reasons of security or privacy.

This additional hazard perception generates improved worker safety.

While the present disclosure has been described in connection with specific embodiments thereof, it will be understood that it is capable of further modification(s). This application is intended to cover any variations uses or adaptations of the present disclosure following in general, the principles of the present disclosure and including such departures from the present disclosure as come within known or customary practice within the art to which the present disclosure pertains and as may be applied to the essential features hereinbefore set forth.

As the present disclosure may be embodied in several forms without departing from the spirit of the essential characteristics of the present disclosure, it should be understood that the above described embodiments are not to limit the present disclosure unless otherwise specified, but rather should be construed broadly within the spirit and scope of the present disclosure as defined in the appended claims. The described embodiments are to be considered in all respects as illustrative only and not restrictive.

Various modifications and equivalent arrangements are intended to be included within the spirit and scope of the present disclosure and appended claims. Therefore, the specific embodiments are to be understood to be illustrative of the many ways in which the principles of the present disclosure may be practiced. In the following claims, means-plus-function clauses are intended to cover structures as performing the defined function and not only structural equivalents, but also equivalent structures.

It should also be noted that where a flowchart is used herein to demonstrate various aspects of the present disclosure, it should not be construed to limit the present disclosure to any particular logic flow or logic implementation.

“Comprises/comprising” and “includes/including” when used in this specification is taken to specify the presence of stated features, integers, steps or components but does not preclude the presence or addition of one or more other features, integers, steps, components or groups thereof. Thus, unless the context clearly requires otherwise, throughout the description and the claims, the words ‘comprise’, ‘comprising’, ‘includes’, ‘including’ and the like are to be construed in an inclusive sense as opposed to an exclusive or exhaustive sense; that is to say, in the sense of “including, but not limited to”.

FIGS. 1-5 show example configurations with relative positioning of the various components. If shown directly contacting each other, or directly coupled, then such elements may be referred to as directly contacting or directly coupled, respectively, at least in one example. Similarly, elements shown contiguous or adjacent to one another may be contiguous or adjacent to each other, respectively, at least in one example. As an example, components laying in face-sharing contact with each other may be referred to as in face-sharing contact. As another example, elements positioned apart from each other with only a space there-between and no other components may be referred to as such, in at least one example. As yet another example, elements shown above/below one another, at opposite sides to one another, or to the left/right of one another may be referred to as such, relative to one another. Further, as shown in the figures, a topmost element or point of element may be referred to as a “top” of the component and a bottommost element or point of the element may be referred to as a “bottom” of the component, in at least one example. As used herein, top/bottom, upper/lower, above/below, may be relative to a vertical axis of the figures and used to describe positioning of elements of the figures relative to one another. As such, elements shown above other elements are positioned vertically above the other elements, in one example. As yet another example, shapes of the elements depicted within the figures may be referred to as having those shapes (e.g., such as being circular, straight, planar, curved, rounded, chamfered, angled, or the like). Further, elements shown intersecting one another may be referred to as intersecting elements or intersecting one another, in at least one example. Further still, an element shown within another element or shown outside of another element may be referred as such, in one example.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

1. A wearable device associated with a zone entry warning device, wherein the wearable device comprises a receiver associated with a stretchable band.

2. The wearable device according to claim 1, wherein the stretchable band is a closed loop of polymeric material.

3. The wearable device according to claim 1, wherein the receiver and zone entry warning devices are both embedded in the stretchable band.

4. The wearable device according to claim 1, wherein the wearable device is removably attached to a safety spectacle frame.

5. A system for zone entry warning, the system comprising:
a transmitter adapted to provide as an output, a signal from a predetermined zone,
a zone entry warning device,
a wearable receiver associated with a stretchable band, the receiver being adapted to be responsive to the signal when proximate the predetermined zone and to initiate the zone entry warning device.

6. A method for zone entry warning, the method comprising:
locating a transmitter proximate a predetermined zone, the transmitter being adapted to provide a signal as an output,
removably attaching a zone entry warning device to a subject,
removably attaching a stretchable band to the subject, the stretchable band comprising a receiver, the receiver being adapted to be responsive to the signal when proximate the zone and to initiate the zone entry warning device.

7. The wearable device according to claim 1, wherein the receiver is embedded in a stretchable band.

8. The wearable device according to claim 2, wherein the stretchable band material is silicone.

9. The system according to claim 5, wherein the receiver is embedded in the stretchable band.
